(19) United States
(12) Patent Application Publication
(10) Pub. No.: US 2005/0227175 A1
(43) Pub. Date: Oct. 13, 2005

(54) Method of manufacture of integrated optical devices

(75) Inventor: Yakov Sidorin, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(73) Assignee: Coronado Instruments, Inc., Irvine, CA (US)

(21) Appl. No.: 11/101,971

(22) Filed: Apr. 8, 2005

Related U.S. Application Data
(60) Provisional application No. 60/560,942, filed on Apr. 9, 2004.

(51) Int. Cl. G03C 1/492

(52) U.S. Cl. 430/270.1

(57) ABSTRACT

A hybrid sol-gel material is placed in optical contact with two optical surfaces and the surfaces are precisely aligned as necessary to meet desired optical specifications. The sol-gel material filling the gap between the surfaces is then cured, such as by exposure to UV radiation. This allows, for example, the fabrication of a solid-spaced etalon filter where the spacer layer of the etalon is formed with sol-gel material to a precise dimension defined by the alignment of the optical surfaces. The optical properties of the hybrid-glass structure formed between the optical surfaces may be fine tuned by varying the exposure of the sol-gel material to the curing agent. Furthermore, the hybrid-glass structure of the invention can be patterned using standard photolithographic techniques.

### RELATED APPLICATIONS

This application is based on and claims the priority of U.S. Provisional Application Ser. No. 60/560,942, filed Apr. 9, 2004.

### BACKGROUND OF THE INVENTION

1. Field of the Invention

This invention relates to the general field of optical instrumentation and, in particular, to a method for precisely forming and integrating optical components using hybrid optical materials.

2. Description of the Prior Art

The accurate relative positioning and orientation of optical components in optical devices is critical at every step of manufacturing. As those skilled in the art readily understand, the degree of precision required for proper device operation increases when the dimensions of the device approach the wavelength of light, as well as when the operation of the device is based on interference and/or diffraction effects.

For example, in solar astronomy, atmospheric sciences and other spectroscopic applications it is frequently necessary to use optical filters for separating specific spectral bandwidths or for reducing the light radiated by very bright objects, such as the sun. One such optical filter employed in these applications is the Fabry-Perot etalon filter, which is composed of two precisely parallel optical surfaces separated by a gap in air, vacuum, or a dielectric material. However, the mass fabrication of high-performance etalon filters with sufficiently precise characteristics (such as highly precise bandwidths and passbands for use in narrow-band spectroscopic applications) has proven to be rather difficult. In order to meet the optical tolerances required in positioning the etalon components, extremely precise, time consuming and expensive manufacturing techniques must be used.

For example, an air-spaced etalon filter 10, as shown in the side view of FIG. 1, includes two parallel flat surfaces 12,14 (also known as etalon plates) separated in air by spacers 16,18 that define an etalon gap 20 equal to the thickness of the spacers 16,18. The optical quality and efficiency of the etalon 10 is governed by the flatness of the plates 12,14 and the parallelism and thickness of the gap 20. The thickness and parallelism of the gap are controlled by the ability to manufacture spacers with adequate thickness and parallel sides. If the spacers have wrong or non-uniform thicknesses, or if they differ in thickness from each other, then the gap between the optical surfaces is not uniform and the resulting finesse of the etalon is significantly reduced. For example, if the etalon 10 were to be used in a typical H-alpha solar filter (with operating wavelength of approximately 656.3 nm and bandwidth on the order of 0.5 Angstrom), the spacers 12,14 should provide a gap of about 100 μm with a precision on the order of one micron. The construction of such etalons has been a rather artful skill in the industry, thus limiting their fabrication to only a few units at a time. As a result, etalons of this type are very expensive.

In U.S. Pat. No. 6,181,726, David Lunt describes a method for fabricating high-performance etalons with a high degree of parallelism across the entire etalon surface. As illustrated in the top view of FIG. 2, all spacers 24,26 employed in the fabrication of the etalon 28 according to the invention are made from the same local area of the spacer substrate, which results in a higher degree of thickness uniformity among the spacers. Moreover, the use of a centrally located spacer 26 in addition to the conventional peripheral spacers 24 increases the uniformity of the etalon gap across the entire surface of the etalon plates. Although this approach improves the uniformity of the etalon gap, it addresses neither the issue of thickness precision in the gap (which affects the position of the spectral peak of the etalon) nor the mass-producibility of the etalon.

To the extent that conventional optical glasses and manufacturing techniques are used in the fabrication of etalon filters, the limitations described above are unavoidable. Thus, there remains a need for an approach that overcomes these limitations by providing precise positioning of the etalon plates without the use of conventional spacers or conventional assembly techniques.

### SUMMARY OF THE INVENTION

A different class of materials than used in conventional optics, known as hybrid optical glasses, has been extensively used in integrated optics and other interdisciplinary technologies. Hybrid optical glasses have been of special interest to the photonic industry because they may be formed using well-developed and controllable sol-gel mixtures of inorganic oxides and organic polymers with optical properties that can be tailored to desired specifications. The latter are achieved by appropriate UV and/or temperature exposure of the hybrid material until the desired specifications are reached. Thus, hybrid optical glasses provide a cost-effective and convenient route for preparing multi-component optics that could not be formed by conventional glass-melting processes.

Utilizing these known hybrid optical glasses, this invention provides an approach for the precise and time-efficient integration of optical components without the use of independently fabricated spacers. The invention is based on the idea of using hybrid optical sol-gel materials and standard lithographic techniques for the formation of spacers between optical components in a single processing step during the manufacture of an optical device.

The invention consists of forming a hybrid-glass structure between two optical surfaces precisely aligned with respect to each other. The process involves placing a hybrid sol-gel material in optical contact with the two surfaces, precisely aligning the surfaces relative to one another (as necessary to meet the optical specifications of the device) with the sol-gel material filling the gap between the surfaces, and curing the sol-gel material using an appropriate curing agent (such as UV light). This allows, for example, the fabrication of a solid-spaced etalon filter where the spacer layer of the etalon is formed with sol-gel material to a precise dimension defined by the alignment of the optical surfaces.

In addition, the invention enables tailoring of the optical properties of the hybrid-glass structure formed between the optical surfaces. This is achieved by varying the exposure of the sol-gel material to the curing agent (which affects the refractive index of the resulting hybrid glass). By characterizing the optical properties of the structure using conventional measurement techniques during the curing process, the exposure to the curing agent may be stopped when the optical properties of the structure reach the desired specifications. For example, the optical length of the gap in a solid-spaced etalon can be controlled by varying the UV exposure of the hybrid material used to form the spacer layer because the degree of curing affects the refractive properties of the resulting hybrid glass. This allows for precise tuning of the peak wavelength of the etalon.

Furthermore, the hybrid-glass structure of the invention can be patterned using standard photolithographic techniques. This is achieved by using an appropriate lithographic mask which blocks the sol-gel material from the UV light in some regions and exposes it to the light in other regions. As a result of such patterning, the cured portion of the material produces a solid patterned structure between the two surfaces, while the non-cured portion of the material can be washed out using a solvent such as isopropanol. This process allows, for example, the fabrication of air-spaced etalons where discrete spacers are formed from a continuous sol-gel layer disposed between the etalon mirrors by UV curing through a lithographic mask.

Various other aspects and advantages of the invention will become clear from the description in the specification that follows and from the novel features particularly pointed out in the appended claims. Therefore, to the accomplishment of the objectives described above, this invention consists of the features hereinafter illustrated in the drawings, fully described in the detailed description of the preferred embodiments, and particularly pointed out in the claims. However, such drawings and descriptions disclose only some of the various ways in which the invention may be practiced.

### BRIEF DESCRIPTION OF THE DRAWINGS

FIG. 1 shows a conventional air-spaced Fabry-Perot etalon in side view.

FIG. 2 shows the top view of a conventional air-spaced etalon fabricated with a central spacer.

FIG. 3 illustrates the layer of photosensitive sol-gel material deposited in optical contact with the mirror surfaces of etalon plates.

FIG. 4 illustrates the process of fabrication and contemporaneous characterization of a solid-spaced etalon filter using hybrid-glass material according to the invention.

FIG. 5 is a side view of a solid-spaced etalon filter manufactured according to the invention.

FIG. 6 illustrates the use of a lithographic mask in the process of fabrication of an air-spaced etalon filter using hybrid-glass material according to the invention.

FIG. 7 shows in top view a dark-field lithographic mask for use in fabricating an air-spaced etalon filter according to the invention.

FIG. 8 illustrates in side view an air-spaced etalon with spacers fabricated from hybrid-glass material according to the invention using the mask of FIG. 7.

FIG. 9 illustrates in side view a re-entrant etalon with the spacers fabricated from hybrid-glass material according to the invention.

FIG. 10 illustrates a diffractive device with tuned optical properties fabricated according to the invention.

FIG. 11 shows a tuned refractive device in the form of an optical wedge fabricated according to the invention.

FIG. 12 shows a tuned refractive device in the form of a lens fabricated according to the invention.

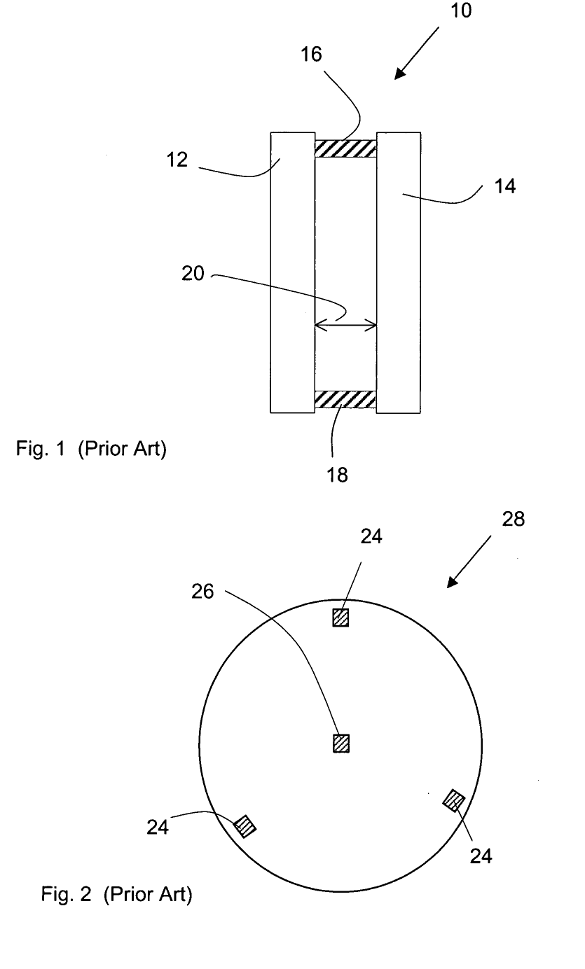

### DETAILED DESCRIPTION OF THE INVENTION

The invention provides a method for high-precision integration of optical surfaces with interspaced spacer components. The method is based on creating a spacer preform by placing hybrid-glass material between the optical surfaces and generating the spacer components from the spacer preform by lithographic processing. Once so generated, the spacers determine the precise relative orientation of the optical surfaces and provide the means of attachment to each other. As a result, in a single processing cycle both the required spacers are formed and the optical surfaces are aligned and attached to the spacers disposed between them. Therefore, in the fabrication of etalon filters, for instance, there is no need to independently manufacture spacers with conventional techniques nor to assemble the etalon plates and the spacers in a separate step.

Hybrid materials, which are composed of inorganic oxides covalently bonded to organic polymers, have been used in different fields of optics, such as integrated optics, to prepare mono- and multi-component optical glasses (also known as hybrid glasses) using known sol-gel technology. Sol-gel techniques enable the processing of hybrid glasses at low temperatures in variable shapes, such as monoliths, films, fibers, or nano-sized powders. Spin-, dip-, or flow-coating methods are typically used to apply these hybrid glasses on various optical substrates under variable conditions, and photo-exposure (typically UV light) and/or heat exposure are used to cure (dry, harden) and even photo-lithographically pattern these formulations to create thin or thick films, waveguiding structures, and micro-optical elements. The basic processes involved in photo-patterning of any of such hybrid materials are well described in the art.

For example, methacryloxypropyl-trimethoxysilane (MAPTMS) is a UV-curable moiety that enables spatially selective curing of sol-gel matrices. When illuminated with UV light (either by flood exposure or exposure through an appropriately patterned mask), a photoinitiator in the material provides radicals which react with the unsaturated groups of MAPTMS. The polymerization reaction propagates by radical addition to unsaturated groups of MAPTMS. After UV exposure, the non-polymerized MAPTMS is washed away using isopropanol, while the polymerized hardened portion remains.

Several properties of these photo-patternable materials, both as currently available in commerce or as specifically synthesized in the laboratory, are particularly beneficial for the invention. They are characterized by variable optical properties (such as tunable index of refraction, low dispersion, high transmission); compatibility with large-scale (wafer-scale) integration; low-temperature processing; photosensitivity; small extinction coefficient; and the possibility of using the same material in both optical and mechanical roles. Thus, etalon spacers and filters may be fabricated from such materials according to the invention with significant advantages over those manufactured with traditional optical techniques. First, the method of the invention inherently defines the geometry of the spacers as needed to fit perfectly between the etalon plates. Second, solid-spaced etalons so integrated can be easily tuned to desired specifications during the process of spacer formation by varying the exposure of the spacer material to UV light.

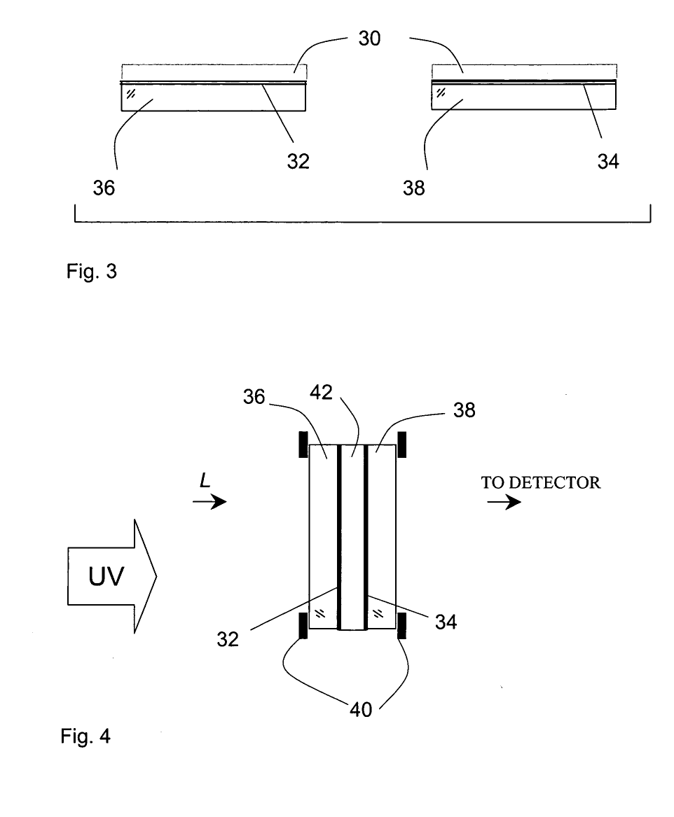

In view of the above, the terms “hybrid-glass materials,” “sol-gel materials,” “hybrid glasses” and related terms are all used in this disclosure to refer to curable sol-gel materials with properties suitable for optical applications. In particular, in their uncured state, these materials are characterized by sufficient fluidity to allow their shaping to produce a desired perform which can then be cured to produce a solid structure with the same shape. Referring to the figures, wherein like parts are designated throughout with like numerals and symbols, FIGS. 3-5 illustrate schematically the process flow of fabrication of a solid-spaced etalon filter according to the invention. FIG. 3 shows two layers 30 of suitably synthesized hybrid glass sol-gel material disposed in optical contact with the mirror surfaces 32,34 of two respective etalon plates 36,38. The layers 30 are formed using any conventional method, such as by spin, dip, or flow coating.

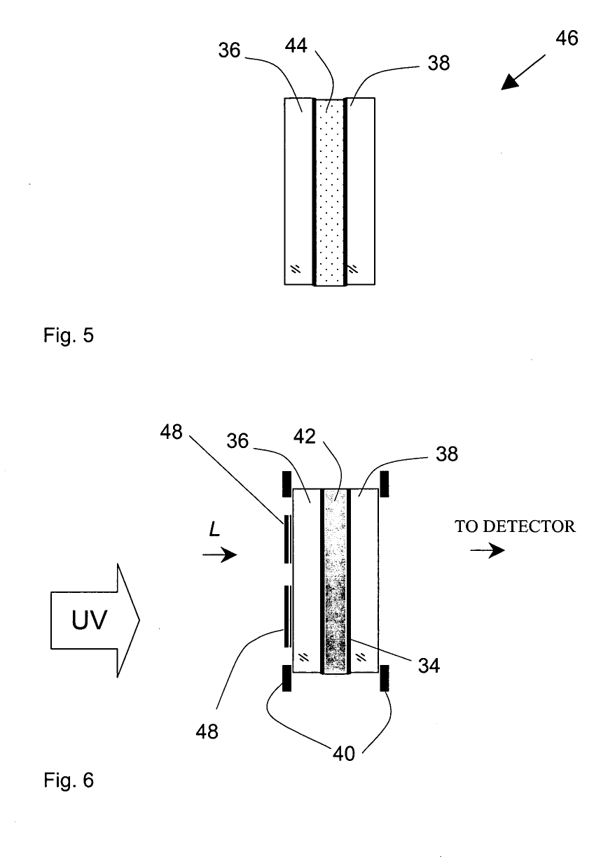

As illustrated in FIG. 4, the substrates 36,38 are then appropriately mounted in an alignment mechanism 40 which allows both translational and angular coordination of the relative position of the substrates. The substrates are aligned with the mirrors 32,34 parallel to each other and are precisely spaced apart as required to meet predetermined target performance specifications. This may be confirmed with any conventional characterization technique, such as by interferometric measurements conducted in throughput with a monochromatic source of light L. As the substrates 36,38 are aligned, the sol-gel layers 30 form a preform 42 having the geometry of the etalon spacer layer to be fabricated. After the etalon plates have been aligned, the sol-gel preform 42 is exposed to UV light, which cures it by activating the process of polymerization of the sol-gel material. As illustrated in FIG. 5, the cured sol-gel material forms a hybrid-glass spacer 44 that fills the gap between the mirrors 32,34 and attaches the plates of the etalon 46 to each other.

The curing process of the preform 42 is accompanied by a gradual change in the refractive index of the material as a function of the degree of UV exposure. Therefore, by controlling the amount of UV exposure of the preform 42, it is possible to vary the ultimate refractive index of the spacer 44 of the etalon and to achieve the required target specifications. This allows tuning of the precise position of the peak wavelength of the solid-spaced etalon filter 46 during its process of fabrication. The control of the exposure to UV light may be provided in conventional manner on the basis of feedback from in-situ optical characterization.

The invention also allows fabrication of air-spaced etalon filters. As illustrated in FIGS. 6-8, after the layer 30 of sol-gel material has been placed in optical contact with the etalon mirrors 32,34, as shown in FIG. 3, and the etalon plates have been precisely aligned and locked in place with respect to each other, the sol-gel preform 42 confined between the mirror surfaces of the etalon plates is exposed to the UV light through an appropriate lithographic mask 48 (as illustrated in FIG. 6). The lithographic mask 48 may be a stand-alone element positioned in front of the etalon plate 36 facing the UV-light source, or it may have been previously integrated within the surface of the etalon plate.

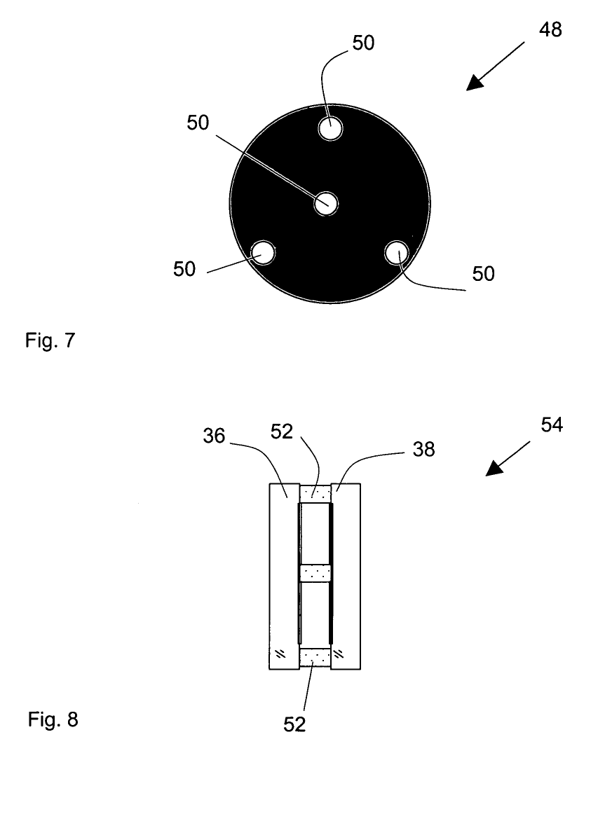

The top-view of a dark-field lithographic mask 48 with four openings 50 (three positioned along the perimeter and one in the center of the mask) suitable for the process of the invention is illustrated in FIG. 7. As a result of using the mask 48, the only portions of the preform 42 that are cured are those exposed to the UV light through the openings 50 in the mask. The remaining portion of the preform, blocked by the mask, is not polymerized and is easily washed out using a conventional solvent, such as isopropanol. Accordingly, the resulting etalon spacer structure consists of a set of discrete spacers 52 that separate and attach the plates of the air-spaced etalon 54, as shown in the side view of FIG. 8.

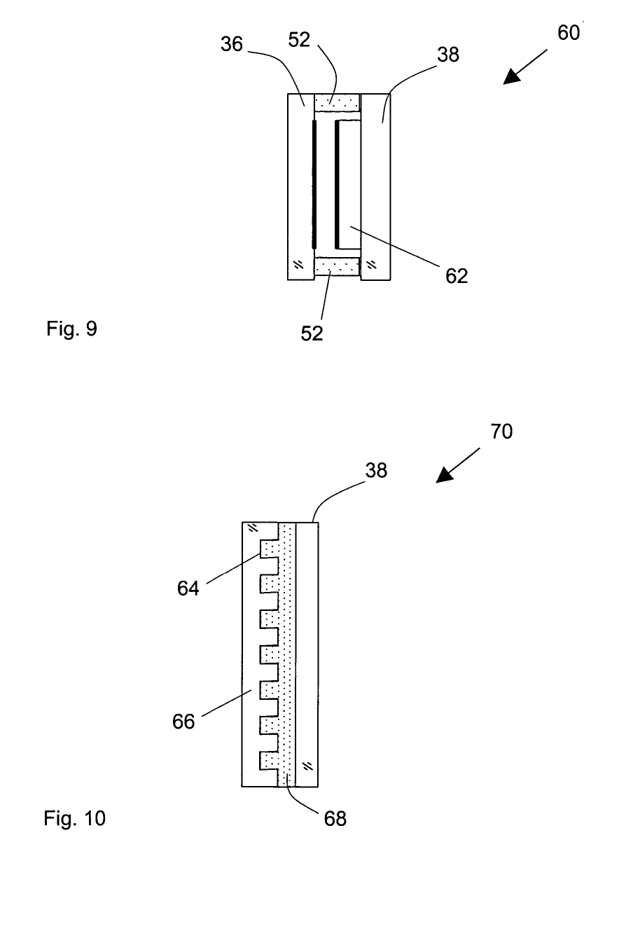

Thus, the invention provides a simple and precise method of fabrication of etalon filters where spacers are constructed in situ from hybrid-glass sol-gel materials using lithographic techniques. As would be clear to the one skilled in the art, the same technique can be used advantageously with appropriate changes to manufacture any device that includes a combination of integrated optical components. For instance, re-entrant etalon filters, which are characterized by a third plate known as a “riser” between the parallel mirror surfaces, can be fabricated in like fashion using the method of invention. As illustrated in FIG. 9, the etalon gap in a re-entrant etalon 60 is defined by the difference in thickness between the spacers 52 and the riser 62. The spacers may be fabricated from hybrid sol-gel material using a mask of the type illustrated in FIG. 7 and the etalon gap may be fine tuned according to the invention during curing of the hybrid glass material.

It is also clear that the invention may be used to integrate optical surfaces that are not parallel or flat. To the extent that any two or more optical surfaces need to be combined, the method of the invention can be used to form appropriately shaped optical element between them. For example, as illustrated in the side view of FIG. 10, the optical surface 64 of a substrate 66 may be spatially patterned as a relief diffraction grating. Then, by curing a sol-gel preform 68 prepared to fill the gap between the substrates 38,66, the diffractive device 70 may be formed as described. The spectral properties of this device can also be adjusted during the fabrication step, if necessary, by controlling the exposure of the preform 68 to the UV light.

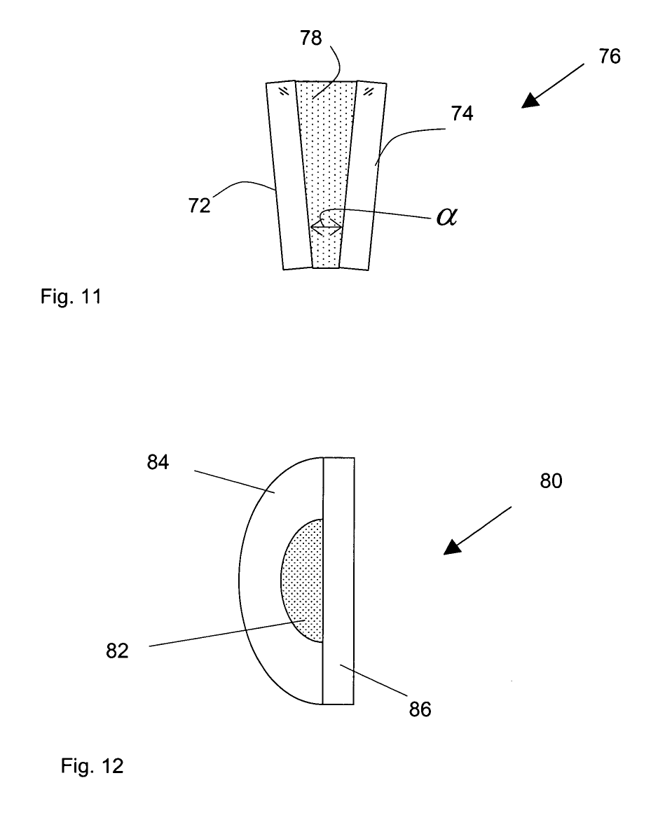

Similarly, the invention may be used advantageously to manufacture refractive devices with fine-tuned refractive properties. FIG. 11 illustrates a type of such a device in the form of optical plates 72,74 aligned at an angle α to form an optical wedge 76. FIG. 12 illustrates a lens 80 formed by a hybrid-glass spacer 82 cured in situ between two appropriately shaped optical structures 84,86. The refractive properties of the wedge and lens can again be tailored to required target specifications (such as desired refractive effects) by controlling the exposure of the hybrid-glass spacers 78 and 82 to the curing source of radiation.

Thus, while the inventions has been shown and described in what are believed to be the most practical and preferred embodiment, it is recognized that departures can be made therefrom within the scope of the invention. Therefore, the invention is not to be limited to the details disclosed herein, but is to be accorded the full scope of the claims so as to embrace any and all equivalent apparatus and methods.

1. A method of manufacturing an integrated optical device comprising the following steps:
placing a curable material between and in contact with two optical surfaces of the device, said surfaces being disposed in a predetermined relative alignment designed to produce a target optical response; and
curing the material to form a solid spacer between the surfaces.

2. The method of claim 1, wherein said device is a solid-spaced etalon and the two optical surfaces are aligned parallel to one another at a distance designed to produce a predetermined spectral response.

3. The method of claim 1, wherein said device is a diffractive device and the two optical surfaces are aligned with respect to one another in a configuration designed to produce a predetermined diffractive response.

4. The method of claim 1, wherein said device is a refractive device and the two optical surfaces are aligned with respect to one another in a configuration designed to produce a predetermined refractive response.

5. The method of claim 1, wherein said curing step is carried out by exposing the material to a source of radiation, and further including the steps of:
placing a mask in front of the material exposed to said radiation, said mask being adapted to block the radiation according to a predetermined pattern and create zones of unexposed material; and
after curing, removing the unexposed material from the solid spacer.

6. The method of claim 5, wherein said device is an air-spaced etalon and the two optical surfaces are aligned parallel to one another at a distance designed to produce a predetermined spectral response.

7. The method of claim 5, wherein said device is a re-entrant etalon and the two optical surfaces are aligned parallel to one another at a distance designed to produce a predetermined spectral response.

8. The method of claim 1, further including the steps of:
monitoring an optical response of the device during the curing step; and
terminating the curing step when the optical response substantially matches said target optical response.

9. The method of claim 8, wherein said device is a solid-spaced etalon and the two optical surfaces are aligned parallel to one another at a distance designed to produce a predetermined spectral response.

10. The method of claim 8, wherein said device is a refractive device and the two optical surfaces are aligned with respect to one another in a configuration designed to produce a predetermined refractive response.

11. The method of claim 5, further including the steps of:
monitoring an optical response of the device during the curing step; and
terminating the curing step when the optical response substantially matches said target optical response.

12. The method of claim 11, wherein said device is an air-spaced etalon and the two optical surfaces are aligned parallel to one another at a distance designed to produce a predetermined spectral response.

13. The method of claim 11, wherein said device is a re-entrant etalon and the two optical surfaces are aligned parallel to one another at a distance designed to produce a predetermined spectral response.

14. The method of claim 1, wherein said curable material is a hybrid glass material and said curing step is carried out by exposure to UV radiation.

15. The method of claim 5, wherein said curable material is a hybrid glass material and said curing step is carried out by exposure to UV radiation.

16. The method of claim 7, wherein said curable material is a hybrid glass material and said curing step is carried out by exposure to UV radiation.

17. The method of claim 11, wherein said curable material is a hybrid glass material and said curing step is carried out by exposure to UV radiation.

18. A solid-spaced etalon manufactured according to the process of claim 1.

19. An air-spaced etalon manufactured according to the process of claim 1.

20. A re-entrant etalon manufactured according to the process of claim 1.

21. A refractive device manufactured according to the process of claim 1.

22. A diffractive device manufactured according to the process of claim 1.
